(19) United States
(12) Patent Application Publication
(10) Pub. No.: US 2008/0004762 A1
(43) Pub. Date: Jan. 3, 2008

(54) Single chip automobile diagnostic tool

(76) Inventors: Jay E. Seashore, Phoenix, AZ (US); Nigel T. Webster, Wiltshire (GB)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/476,047

(22) Filed: Jun. 28, 2006

(51) Int. Cl. G06F 19/00

(52) U.S. Cl. 701/29; 340/438

(57) ABSTRACT

An application specific integrated circuit (ASIC) is provided to a vehicle diagnostic tool that includes a power supply module, a keyboard interface, an oscillator, a microcontroller, a vehicle data link controller, a vehicle interface, a display controller and a memory interface. The ASIC allows for better control of components that are parts of the vehicle diagnostic tool including performance and compatibility.

### FIELD OF THE INVENTION

The present invention relates generally to a vehicle diagnostic tool. More particularly, the present invention relates to an application specific integrated circuit for the vehicle diagnostic tool.

### BACKGROUND OF THE INVENTION

Automobile diagnostic tools, such as scan tools, are used to diagnosis problems with a vehicle. The scan tools are linked to the vehicle's computer via a data link connector. Once linked, the scan tools can query the vehicle's computer with the appropriate vehicle communication protocols and collect vehicle diagnostic data. Once collected, the diagnostic data can be displayed on the display so that a technician can make the appropriate diagnosis.

The scan tool can be expensive due to the components that make up the scan tool. The components can include a processor, memory, communication protocol transmitter and receivers and other components. These components are typically purchased from various vendors and then assembled into a scan tool. Because the components are purchase from various vendors, good price points for the components are hard to obtain. Additionally, since these components are from various vendors, when assembled together can cause the scan tool to be in a larger form factor then necessary. Further, since the components are from various vendors, it's difficult to also control the power consumption of the scan tool since difference vendors will require different power for their individual components.

Accordingly, it is desirable to provide a scan tool that can have components that are low in cost and power and have a small form factor. This will allow for a scan tool to be competitive and less expensive to purchase.

### SUMMARY OF THE INVENTION

The foregoing needs are met, to a great extent, by the present invention, wherein in one aspect an apparatus is provided that in some embodiments provides application specific integrated circuit (ASIC) for a vehicle diagnostic tool that includes a power supply module, a keyboard interface, an oscillator, a microcontroller, a vehicle data link controller, a vehicle interface, a display controller and a memory interface.

In accordance with one embodiment of the present invention, an application specific integrated circuit for a vehicle diagnostic tool is provided and can include a microcontroller that can allow the vehicle diagnostic tool to communicate with a vehicle electronic control unit, a keyboard interface module that can allow a user to input information into the vehicle diagnostic tool, an oscillator having a clock module which can provide clock information to the microcontroller, a vehicle data link controller that can control at least one vehicle communication protocol, a vehicle interface that can allow the vehicle diagnostic tool to interface with the vehicle electronic control unit, a memory interface that can provide memory to the microcontroller, a display controller that can control a display of the vehicle diagnostic tool, and a power supply module that can supply power to the ASIC, wherein the keyboard interface module, the oscillator, the vehicle data link controller, the vehicle interface, the memory interface, the display controller and the power supply module can be in communication with the microcontroller.

In accordance with another embodiment of the present invention, a method of communicating with a vehicle electronic computing unit with a vehicle diagnostic tool is provided and can include connecting a vehicle interface connector to the vehicle electronic computing unit, powering the vehicle diagnostic tool on, receiving data transmitted in a communication protocol through an application specific integrated circuit (ASIC), and displaying the data on a display.

In accordance with yet another embodiment of the present invention, an application specific integrated circuit for a vehicle diagnostic tool is provided and can include a processing means that can allow the vehicle diagnostic tool to communicate with a vehicle electronic control unit, an interface means that can allow a user to input information into the vehicle diagnostic tool, a timing means having a clock module which can provide clock information to the processing means, a vehicle data link controlling means that can control at least one vehicle communication protocol, a vehicle interface means that can allow the vehicle diagnostic tool to interface with the vehicle electronic control unit, a memory interface means that can provide memory to the processing means, a display controller means that can control a display of the vehicle diagnostic tool, and a power supply means that can supply power to the ASIC, wherein the interface means, the timing means, the vehicle data link controller means, the vehicle interface means, the memory interface means, the display controller means and the power supply means are in communication with the processing means.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a front view illustrating a scan tool according to an embodiment of the invention.

FIG. 2 illustrates a block diagram of the ASIC of the present invention.

FIG. 3 illustrates a vehicle data link controller block diagram according to an embodiment of the invention.

### DETAILED DESCRIPTION

The invention will now be described with reference to the drawing figures, in which like reference numerals refer to like parts throughout. An embodiment in accordance with the present invention provides an application specific integrated circuit (ASIC) designed for a scan tool.

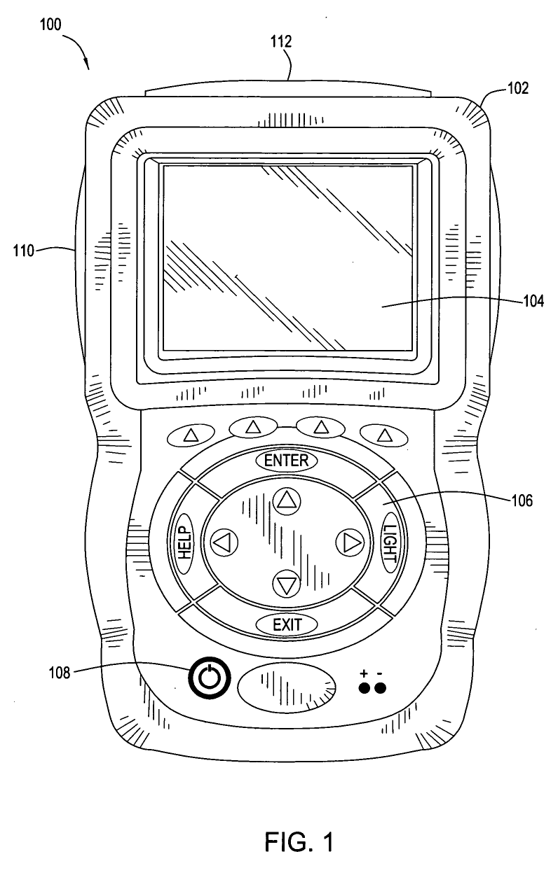

FIG. 1 is a front view illustrating a scan tool 100 according to an embodiment of the invention. The scan tool can be any computing device, such as, for example, the Nemisys scan tool from Service Solutions (a unit of the SPX Corporation) in Owatonna, Minn. The scan tool 100 includes a housing 102 to house the various components of the scan tool, such as a display 104, a keyboard or user interface 106, a power key 108, a memory card reader 110 and a connector interface 112. The display 104 can be any display or screen, for example, LCD (liquid crystal display), VGA (video graphics array), touch screen (can also be a user interface), etc. The user interface 106 allows the user to interact with the scan tool in order to operate the scan tool as desired. The power key 108 allows the user to turn the scan tool on and off, as required.

Memory card reader 110 can be a single type card reader, such as a compact flash card, floppy disc, memory stick, secure digital, flash memory or other types of memory. The memory card reader 110 can be a reader that reads more than one of the aforementioned memory such as a combination memory card reader. Additionally, the card reader 110 can also read any other computer readable medium, such as CD, DVD, UMD, etc.

The connector interface 112 allows the scan tool 100 to connect to an external device, such as an ECU (electronic control unit) of a vehicle, a computing device, an external communication device (such as a modem), a network, etc. through a wired or wireless connection. Interface 112 can also include a USB, FIREWIRE, modem, RS232, RS48J, and other connections to communicate with external devices, such as a hard drive, USB drive, CD player, DVD player, UMD player or other computer readable medium devices.

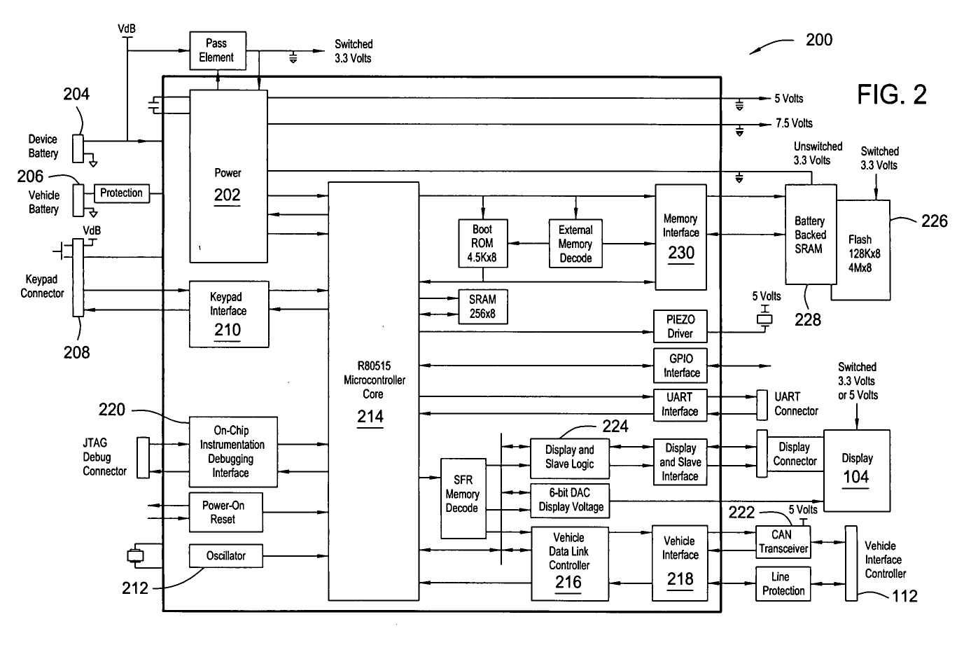

FIG. 2 illustrates a block diagram of the ASIC 200 of the present invention. The ASIC 200 includes generally a power supply module 202, a keyboard interface 210, an oscillator 212, a microcontroller 214, a vehicle data link controller 216, a vehicle interface 218, a display controller 224 and a memory interface 230.

The power supply module 202 provides power to the ASIC and the rest of the scan tool. The power supply module can be powered by the internal device battery 204 (for example, 4 AA batteries) or from the vehicle battery 206, when the scan tool 100 is connected to the ECU of the vehicle. In one embodiment, the power supply module can include three regulators (not shown) and one regulator controller (not shown). However, as many regulators and regulator controllers can be utilized as required and are not limited to the amount disclosed herein. A 7.5V regulator and 5V charge pump are used to provide voltage swings and input references for the vehicle interface transceivers. The 3.3V supplier is used in tandem with an external pass FET to allow for higher current requirements. For example, the 3.3V can supply the microcontroller, external Flash memory, and the display circuits. A second 3.3 regulator (unswitched) can be powered and is used to provide power to the external battery-backed SRAM. A 5V supply can power the vehicle interface or the CAN (control area network) transceiver (discussed below).

The power supply module also include a low battery detect circuit used to digitally signal the microcontroller that the tool power has reached an unsafe voltage level so that appropriate action can be taken by the microcontroller to signal a shut down is imminent or for the user to plug the scan tool into another battery source, such as the vehicle's battery. Additionally, the power supply module can include the power key 108 that includes a momentary external switch that when pressed for the first time, powers the scan tool on and when pressed a second time will interrupt the microcontroller. The power supply module can provide a digital power-on-reset to hold the processor reset during power up and down cycles.

The keyboard interface 210 supports a keyboard connector 208, which is connected to the user interface or keyboard 106. The keyboard may have a matrix of 4×4, for example, or any configuration desired including an alpha-numeric keyboard. The keyboard 106 can include function keys, arrow keys or any other type of keys that can manipulate the scan tool 100 in order to operate the software. Other input device, such as a stylus, touch-screen, mouse or other pointing devices are also contemplated in this embodiment.

An oscillator 212 can include a clock module and provide all the necessary clocks for the internal digital circuits, including the input clock for the microcontroller 214 (discussed below). Additionally, the oscillator 212 can provide the clock for the CAN bit processing (discussed below). In one embodiment, the oscillator clock runs at 16 MHz and can be used to provide the CAN bit processing timing to achieve the 1 Mbit maximum data rate. Other clock speed and data rates are also contemplated within this disclosure.

The microcontroller 214 can be any controller or microprocessor that is capable of computing and controlling the scan tool and its function. For examples, the microcontroller can be a R80515 RISC (Reduced-Instruction Set), 8-bit microcontroller clocked at 8 Mhz. The microcontroller can be in communication with an SRAM (static random access memory) and a boot ROM (read only memory) that contains the program that boots the ASIC upon being powered. The memory interface 230 communicates with the memory card reader 110, which can store additional memory, such as a battery backed SRAM 228 and/or a flash memory 226, for use by the microcontroller.

The microcontroller 214 can include the standard set of 8051 compatible peripherals plus a second data pointer to speed up memory move instructions. The internal and external peripherals for the R80515 reside in the SFR (special function registers) memory space and can be accessed using 8051 direct memory instructions. SFRs are bit, byte, or word-sized registers that are used to control timers, counters, serial I/O, port I/O, and peripherals.

The ASIC also includes an on-chip instrumentation interface (OCI) 220 that communicates with the microcontroller 214. The OCI includes a start/stop control, unlimited number of software breakpoints, assembly level single-step, and hardware breakpoints. Each hardware breakpoint includes one address/data value and one memory space modifier.

The vehicle data link controller 216 and vehicle digital interface logic 218 interact with the connector interface 112, which connects to the vehicle's ECU in order for the scan tool 100 to interact with the vehicle. The CAN (controlled area network) transceiver 222 also communicates with vehicle data link controller 216, the connector interface 112, and the vehicle digital interface logic 218. The vehicle data link controller 216 possess all the necessary encoder and decoder and all transmitters and receivers for the various communication protocols. The scan tool 100 communicates with the ECU through various communication protocols, such as CAN (ISO 11898), GM 80/160 Baud, GM 8192 ALDL, Chrysler SCI, KOEO (Ford), KOER (Ford), DCL (Ford), ISO 9141, J1850 VPW, J1850 PWM, and J1708. Aperson skilledinthe art will recognize that the ASIC described herein is capable of communicating in other any communication protocol with little or no modifications.

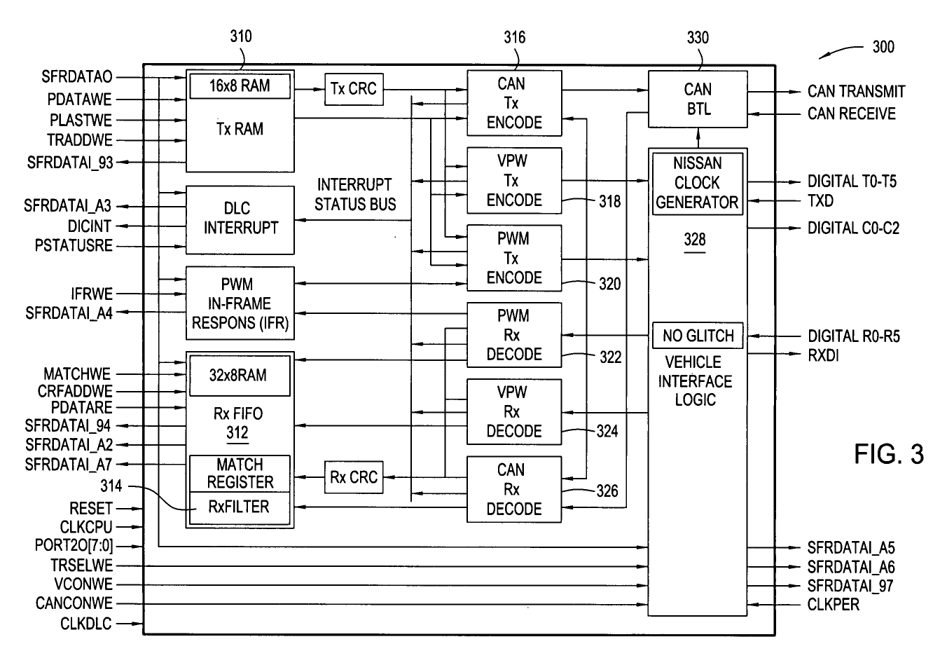

FIG. 3 illustrates a vehicle data link controller block diagram 300 according to an embodiment of the invention. The vehicle data link controller contains the logic to perform the protocols stated above, such as CAN, VPW and PWM communications. Typically, only one protocol is selected at a time, but the ASIC can be designed to communicate in two or more protocols, as desired. The selected protocol will enable one set of encoder/decoder logic corresponding to that protocol. For example, the CAN Tx Encoder 316 and CAN Rx Decoder 326; VPW Tx Encoder 318 and VPW Rx Decoder 324; PWM Tx Encoder 320 and PMW Rx Decoder 324.

Data can be written into the TxRAM 310 by the microcontroller to form a frame for transmission. The TxRAM, for example, can be 16 bytes deep and will be written and read sequentially. If a frame loses arbitration during transmission, the address to the RAM is automatically reset allowing for two additional transmission retries without the microcontroller having to reload the frame into RAM again. Once transmission is enabled, the data in the TxRAM is converted from parallel to serial, encoded and provided to the vehicle interface for transmission. As bits are received from the vehicle interface, they are decoded, converted from serial to parallel and loaded into the RxFIFO 312, where they can be read by the microcontroller. The RxFIFO 312, for example, can be 32 bytes deep and allows the reception of multiple frames. This allows concurrency between the reception of a second frame while the microcontroller is still processing the first. The serial transmit path can select multiple digital outputs to be asserted allowing programmability for the vehicle interface drivers. The receive path can be selected from one of multiple sources allowing different receivers to be used to meet the various vehicle interface standards. The selected receive path is first routed to the “no-glitch” filter on the vehicle interface logic 328 to eliminate any small glitches that may occur during frame reception.

By using a customable ASIC, the scan tool can be manufactured to the specification required by using fewer number of vendors. Additional communication protocols can be readily added or removed due to common pathways that are used to communicate between the vehicle and the ECU. Other components can also be readily added or removed from the ASIC due to a dynamic power supply module that can provide power at different voltages.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An application specific integrated circuit (ASIC) for a vehicle diagnostic tool, comprising:
a microcontroller that allows the vehicle diagnostic tool to communicate with a vehicle electronic control unit;
a keyboard interface module that allows a user to input information into the vehicle diagnostic tool;
an oscillator having a clock module to provide clock information to the microcontroller;
a vehicle data link controller that controls at least one vehicle communication protocol;
a vehicle interface that allows the vehicle diagnostic tool to interface with the vehicle electronic control unit;
a memory interface that provides memory to the microcontroller;
a display controller that controls a display of the vehicle diagnostic tool; and
a power supply module that supplies power to the ASIC, wherein the keyboard interface module, the oscillator, the vehicle data link controller, the vehicle interface, the memory interface, the display controller and the power supply module are in communication with the microcontroller.

2. The integrated circuit of claim 1, where in the vehicle data link controller includes decoders and encoders for the desired communication protocol.

3. The integrated circuit of claim 1, wherein the power supply module supplies the ASIC at different voltages.

4. The integrated circuit of claim 1, wherein the at least one communication protocols can be one of the following CAN (ISO 11898), GM 80/160 Baud, GM 8192 ALDL, Chrysler SCI, KOEO, KOER, DCL, ISO 9141, J1850 VPW, J1850 PWM, and J1708.

5. The integrated circuit of claim 1, wherein the power supply module provides power to a SRAM so that the SRAM can be battery-backed.

6. The integrated circuit of claim 1 further comprises a on-chip instrumentation debugging interface and SFR memory space.

7. The integrated circuit of claim 1 further comprising a filter that eliminates small signal glitches that may be received by the ASIC.

8. The integrated circuit of claim 2, wherein the power supply can provide the proper voltage for the respective communication protocol.

9. A method of communicating with a vehicle electronic computing unit with a vehicle diagnostic tool, comprising:
connecting a vehicle interface connector to the vehicle electronic computing unit;
powering the vehicle diagnostic tool on;
receiving data transmitted in a communication protocol through an application specific integrated circuit (ASIC); and
displaying the data on a display.

10. The communicating method of claim 9, wherein the ASIC comprises:
a microcontroller that allows the vehicle diagnostic tool to communicate with a vehicle electronic control unit;
a keyboard interface module that allows a user to input information into the vehicle diagnostic tool;
an oscillator having a clock module to provide clock information to the microcontroller;
a vehicle data link controller that controls at least one vehicle communication protocol;
a vehicle interface that allows the vehicle diagnostic tool to interface with the vehicle electronic control unit;
a memory interface that provides memory to the microcontroller;
a display controller that controls a display of the vehicle diagnostic tool; and
a power supply module that supplies power to the ASIC, wherein the keyboard interface module, the oscillator, the vehicle data link controller, the vehicle interface, the memory interface, the display controller and the power supply module are in communication with the microcontroller.

11. The communication method of claim 9, wherein powering the vehicle diagnostic tool is powered by a power supply module that supplies the ASIC at different voltages.

12. The communication method of claim 9, wherein receiving data transmitted in a communication protocol is done by encoders and decoders that are part of the ASIC.

13. An application specific integrated circuit (ASIC) for a vehicle diagnostic tool, comprising:
a processing means that allows the vehicle diagnostic tool to communicate with a vehicle electronic control unit;
an interface means that allows a user to input information into the vehicle diagnostic tool;
a timing means having a clock module to provide clock information to the processing means;
a vehicle data link controlling means that controls at least one vehicle communication protocol;
a vehicle interface means that allows the vehicle diagnostic tool to interface with the vehicle electronic control unit;
a memory interface means that provides memory to the processing means;
a display controller means that controls a display of the vehicle diagnostic tool; and
a power supply means that supplies power to the ASIC, wherein the interface means, the timing means, the vehicle data link controller means, the vehicle interface means, the memory interface means, the display controller means and the power supply means are in communication with the processing means.

14. The ASIC of claim 13, where in the vehicle data link controller means includes decoders and encoders means for the desired communication protocol.

15. The ASIC of claim 13, wherein the power supply means supplies the ASIC at different voltages.

16. The ASIC of claim 13, wherein the at least one communication protocols can be one of the following CAN (ISO 11898), GM 80/160 Baud, GM 8192 ALDL, Chrysler SCI, KOEO, KOER, DCL, ISO 9141, Ji850 VPW, J1850 PWM, and J1708.

17. The ASIC of claim 13, wherein the power supply means provides power to a SRAM so that the SRAM can be battery-backed.

18. The ASIC of claim 13 further comprises a on-chip instrumentation debugging interface means and SFR memory space means.

19. The ASIC of claim 13 further comprising a filter means that eliminates small signal glitches that may be received by the ASIC.

20. The ASIC of claim 14, wherein the power supply means provides the proper voltage for the respective communication protocols.
